(19) United States
(12) Patent Application Publication
(10) Pub. No.: US 2003/0044481 A1
(43) Pub. Date: Mar. 6, 2003

(54) Cast ceramic edge or embossed surface for a cutting die

(76) Inventor: Wallace J. Beaudry, Elkhart Lake, WI (US)

Correspondence Address: Ryan Kromholz & Manion, S.C., P.O. Box 26618, Milwaukee, WI, 53226-0618, US

(21) Appl. No.: 09/941,196

(22) Filed: Aug. 28, 2001

(51) Int. Cl. B28B 1/54; B22F 9/00; B29B 9/00; B22D 11/01; B28B 17/00; B26D 1/56

(52) U.S. Cl. 425/6; 83/37; 83/509

(57) ABSTRACT

An improved working die and method of producing it are disclosed wherein a die blank presents a relatively smooth surface and has ceramic material molded on its smooth surface in a configuration corresponding to the design of the product to be cut or formed by the die.

### BACKGROUND OF THE INVENTION

The present invention relates generally to the field of rotary working dies used for working or converting sheet material into die cut, embossed, creased, or scored products, for example, cardboard boxes. More specifically, the invention is directed to an improved working die and process of manufacture thereof.

Rotary working dies, such as cutting dies, have been known in the printing industry for some time. Typical applications include use subsequent to the printing processes for cutting paper stock or label material to its predetermined final configuration.

Electrical discharge machined (EDM) rotary cutting dies represented the last significant advance in the die cutting art. An EDM die is manufactured from a cylindrical die blank, wherein the outer surface area of the blank is machined away until only the cutting edge remains at the original surface height. EDM dies can be manufactured to precise and exact dimensions by automatic, computer numeric controlled (CNC) machines, thereby eliminating any need for expensive manual operations and making it possible to reproduce exact duplicate dies whenever necessary.

Notwithstanding their obvious advantages over prior methods of making rotary dies, EDM dies have several inherent disadvantages. For example, the cutting edge of an average die constitutes only about 10% to possibly 20% of the total surface area of the die blank. Consequently, a substantial amount of metal must be machined away from the blank surface in order to create the raised cutting edges. This not only requires a considerable amount of time for the machining operation, but it also results in a substantial amount of metal waste. Furthermore, the die cutting blanks used heretofore are not reusable. In other words, at the end of a production run or when a die becomes worn, it cannot be used to produce another die, but must be scrapped. The excessive metal wasted during the machining operation coupled with the expense involved with scrapping the used dies constitute significant cost factors which have imposed limitations as to the types of metals which could be economically used for the cutting die blanks.

The next advance in rotary cutting die manufacturing consisted of starting with a cylindrical member or die blank, which is formed from relatively inexpensive material. A weld bead, preferably of a harder and more abrasion resistant alloy, is applied to the peripheral surface of the die blank in a configuration corresponding to the outline of the blank to be formed. The weld bead is then electrical discharge machined to form the required cutting edge.

By utilizing a die blank with a weld bead thereon conforming to the outline of the box blanks, only a minimum of material had to be machined away to form the cutting edge and thus the time required for the machining operation is substantially reduced. The reduction of waste material resulting from the machining operation, coupled with the fact that the die blanks can be recycled by grinding off the weld bead after a production run is completed, makes it economically feasible to employ harder, more abrasive resistant welding materials for the cutting edges whereby the life expectancy of the dies is materially increased.

While being a significant improvement over previous methods, the weld bead method still carries certain disadvantages associated with the traditional manufacture of cutting dies. Precision machining is still required for each die, adding expense in the form of skilled labor or CNC machines. Additionally, the material used to form the cutting edge is limited to weldable metals.

### SUMMARY OF THE INVENTION

The present invention pertains to an improved rotary working die and method of production which retains all of the advantageous features inherent in the known EDM dies, but which can be formed in less time with substantially less material waste and which permits the die blanks to be reused indefinitely by utilizing the method of the present invention.

In a presently preferred embodiment of the invention, a rectangular piece of stock material is first machined on one side. The configuration of the cutting edge is machined into the stock material at a predetermined depth. A rotary cutting tool having a tip with a“v” shaped cross-section is utilized. This process may be carried out on a CNC milling machine or similar device.

After the cutting edge configuration has been machined away, one or more riser forms are cut into the stock material. Each riser form extends from the configuration to an outer edge of the stock material. The riser forms are preferably cut with a second rotary cutting tool having a wider and flatter cross section, such as a “u” shape or a semicircle. The depth of the riser form cuts are preferably less than that of the edge configuration. The function of the riser(s) will become apparent in the following description.

Next, the stock material is wrapped around a rotary die blank, such that the machined side of the stock abuts the surface of the die blank. The rotary die blank is of a relatively inexpensive material and is of known design in the industry. Once the stock material has been circumferentially formed about the die blank, one or more clamps are used to securely hold the stock material in place. Each clamp is tightened to a predetermined torque.

The rotary die blank and stock material assembly is next turned on its side so that the riser(s) extend in an upward direction. Molten ceramic material is then injected into the assembly through the riser opening(s). When a sufficient amount of material to fill the edge configuration has been used, the assembly may be rotated and/or shaken to evenly distribute the ceramic material within the machined groove.

The ceramic material in the assembly is allowed to cool. The cooling process may be monitored and controlled in a number of ways to assure all desired properties emerge during solidification. When the ceramic material has hardened, the clamps and stock material are removed, leaving the ceramic working edge attached to the rotary die.

If the height of the riser(s) are equal to or greater than the height of the working edge, machining of the riser(s) are necessary. Although the riser(s) may be entirely machined away, complete removal is not necessary. The height of the riser(s) only need to be reduced so as not to interfere with the working process, i.e. a height less than that of the cutting edge.

Although the working edge may be formed using any suitable material, ceramics are preferred for their abrasive qualities. Hardness and wear resistance are superior to conventional cutting edge materials. Fine chips of diamond may be included in the ceramic material to increase hardness even further. Additionally, ceramic material wears in service by loss of small chips. The new exposed grains provide sharp cutting surfaces, effectively sharpen the cutting edge through the wearing process. These qualities allow a service life much longer than that of conventional materials.

Another advantage of the present invention is that the rotary die blanks may be recycled after the service life of the working edge has expired. The old working edge may be removed simply by turning the rotary die blank in a lathe, after which a new working edge may be formed on the blank.

A yet further advantage is that the stock material and clamps may be reused as a mold to form additional rotary dies having the same cutting configuration.

A yet further advantage is that a minimal amount of machining time is required to form a finished rotary die.

Moreover, because the fabricating procedures substantially reduce the amount of waste, combinations of materials previously thought to be uneconomical can be utilized whereby the overall cost of the dies is reduced and the normal life expectancy is greatly increased. For example, because the die blank per se is not utilized to provide anything more than a supporting function, a relatively inexpensive, commercially available steel tubing can be used. This provides a lower cost and allows the use of an expensive and superior edge material without an increase in the total cost.

These and other objects and advantages of the present invention will become apparent in the descriptions that follow. The inventor is not aware of any product or process that teaches the present invention.

### DESCRIPTION OF THE DRAWING

FIG. 1 is a perspective view illustrating a rotary die blank for supporting a cutting edge configuration applied in accordance with the teachings of the present invention.

FIG. 1a is a perspective view of a cutting die made according to the present invention and showing cutting blanks to be produced.

FIG. 2 is a perspective view of a rectangular piece of stock material being machined in accordance with this invention.

FIG. 3 perspective view of a rectangular piece of stock material having a grooved riser being machined therein.

FIG. 4 is a cross sectional view taken along lines 4-4 on FIG. 3, and illustrating a V-shaped molding groove.

FIG. 4a is an enlarged view of the encircled area of FIG. 4, and illustrating details of a V-shaped molding groove machined in the stock material of FIG. 3.

FIG. 5a is a cross sectional view similar to that of 4a, but showing a V-shaped groove defining an angle between the side walls of 45°.

FIG. 5b is a cross sectional view similar to that of 4a, but showing a V-shaped groove defining an angle between the side walls of 30°.

FIG. 5c is a cross sectional view similar to that of 4a, but showing a V-shaped groove defining an angle between the side walls of 90°.

FIG. 5d is a cross sectional view similar to that of FIG. 4a, but showing an alternative coved groove design.

FIG. 5e is a cross sectional view similar to that of FIG. 4a but showing yet another alternative groove design and suitable for creasing a fold line in a cut and formed blank material.

FIG. 5f is a cross sectional view similar to that of FIG. 5e, but showing an alternative groove design displaying a relatively rounded area for enlarged creasing of a cut and formed blank.

FIG. 5g is a cross sectional view similar to those of FIGS. 5a-5f, but showing an alternative groove design suitable for forming an embossing edge on a die blank.

FIG. 6 is a fragmentary view of a piece of stock material and particularly showing a riser machined therein.

FIG. 7 illustrates the application of the stock material to the rotary die blank.

FIG. 8 illustrates clamping of the stock material to the rotary die blank.

FIG. 9 illustrates the pouring of molten ceramic material into the rotary die blank and stock material assembly.

FIG. 10 illustrates the longitudinal rotation of the assembly to evenly distribute the molten ceramic material.

FIG. 11 illustrates the removal of the clamps and rectangular stock material from the rotary die and showing the cooled and formed riser and desired cutting and/or creasing die configuration on the rotary die.

FIG. 12 illustrates the machining of the expendable and undesired surface formed by the riser grooves.

FIG. 13 illustrates the present invention in the form of a finished die blank with the riser removed and ready for working a finished sheet material product.

### DETAILED DESCRIPTION

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

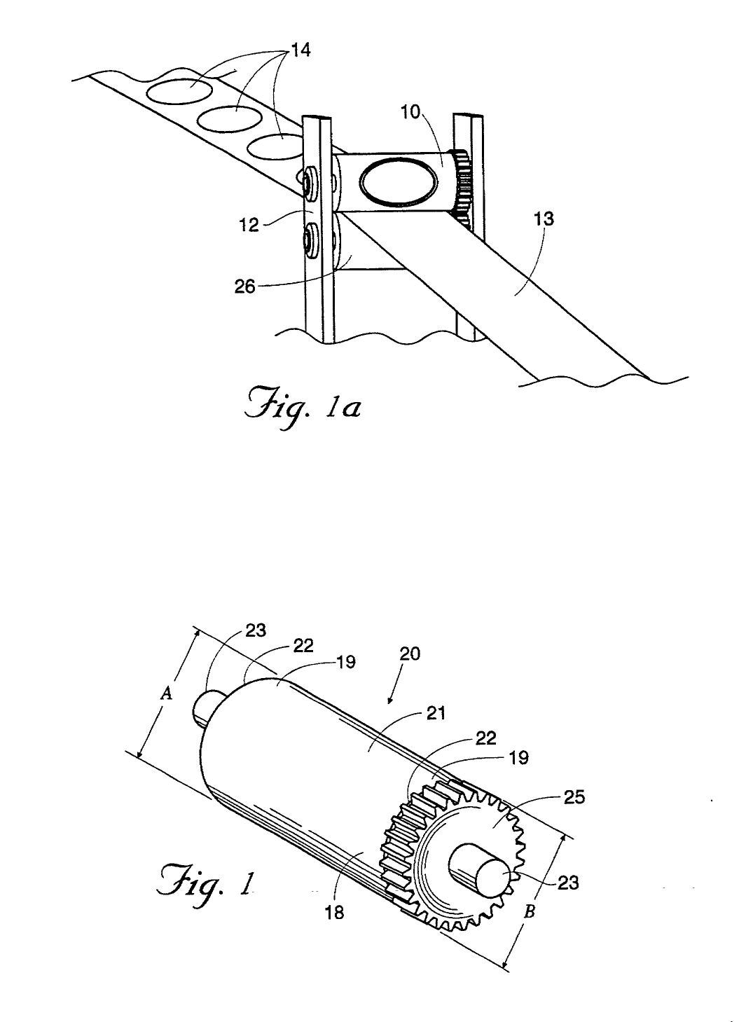

With reference to the views of FIGS. 1 and 1a, the present invention pertains to a rotary cutting die 10 for use in a conventional rotary die cutting machine 12, wherein sheets or continuous webbing of paper stock or adhesive stock 13 with backing material are converted into die cut blanks 14. While the description is directed primarily to paper stock 13, the present invention may be used in conjunction with steel, linoleum, tile, or any other material on which a die machine may do work. As is well known in the art, such rotary cutting dies 10 are mounted for rotation in the spaced side frames of the cutting or printing machine 12, and are adapted to co-act with a backing or anvil roller 26 to cut sheets of stock 13 fed through the nip formed by the die 10 and roller 26. The rotary cutting die 10 is normally driven in unison with the anvil roller 26 by means of a drive gear 25 mounted on the journal shaft at one end thereof, and thus the pitch circle diameter or radius of this gear determines the diameter of the cutting edges formed on the peripheral surface of the rotary cutting die 10. It should be understood that, while the invention is described in conjunction with a rotary die 10 adapted to be driven by a conventional drive gear 25, wherein the diameter of the die cylinder is directly related to the pitch circle diameter of the drive gear, this is not to be regarded as a limitation, as the die cylinder may be driven by other means.

Typical electric discharge machined (EDM) dies were and are made from hardened steel die blanks or drums having a diameter precisely equal to the pitch circle diameter of the associated drive gear. The peripheral surface of the die blank is then electrical discharge machined to leave the cutting edge in relief. This procedure requires machining away approximately 80% to 95% of the surface metal to create the raised cutting edges. This procedure takes a considerable amount of time and produces a substantial amount of waste metal. Moreover, once the diameter of the die blank is reduced in diameter below the reference or pitch circle diameter, it cannot be recycled to form a new die, but must be scrapped at the end of a production run.

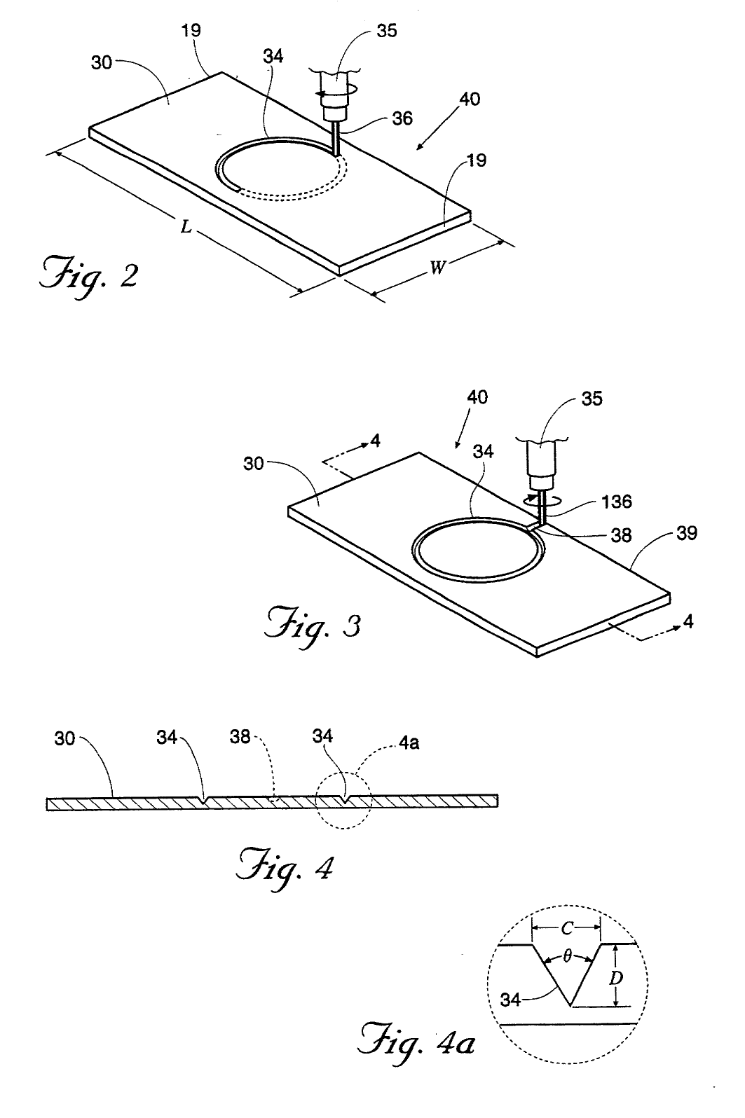

The present invention represents a departure from the known procedures in that the rotary die blanks 20, such as that illustrated in FIG. 1, may be formed using a less expensive flat blank mold 30 (seen in FIG. 2) and a cylindrically-shaped support 21. The cylindrical support 21 used in the present invention may be formed from commercially available steel tubing or other suitable material. The cylindrical support 21 includes a diameter A, and a wall thickness able to withstand the die cutting function. As seen particularly in FIG. 2, the cylindrical support 21 is cut to a predetermined length L, and includes ends 19. The cylindrical support 21 is further provided with end plates 22 affixed at each respective end 19 thereof, and further includes two oppositely disposed, axially extending support journals 23 to support the cylindrical base 21 for rotation in the traditional die cutting or printing machine 12. A drive gear 25 having a predetermined pitch circle diameter B is further secured to a support journal 23 at one end 19 of the die blank 20. As is known in the art, the drive gear 25 serves to synchronize the die 10 rotation with that of a co-acting anvil roller 26, seen in FIG. 1a. The diameter A of the cylindrical support 21 is a predetermined amount less than the pitch circle diameter B of the drive gear 25. The difference in the respective diameters may vary according to the specific application, but it is preferred that the diameter A of the cylindrical support member 21 be approximately five thirty-seconds (5/32) of an inch smaller than the pitch circle diameter B of its corresponding drive gear 25.

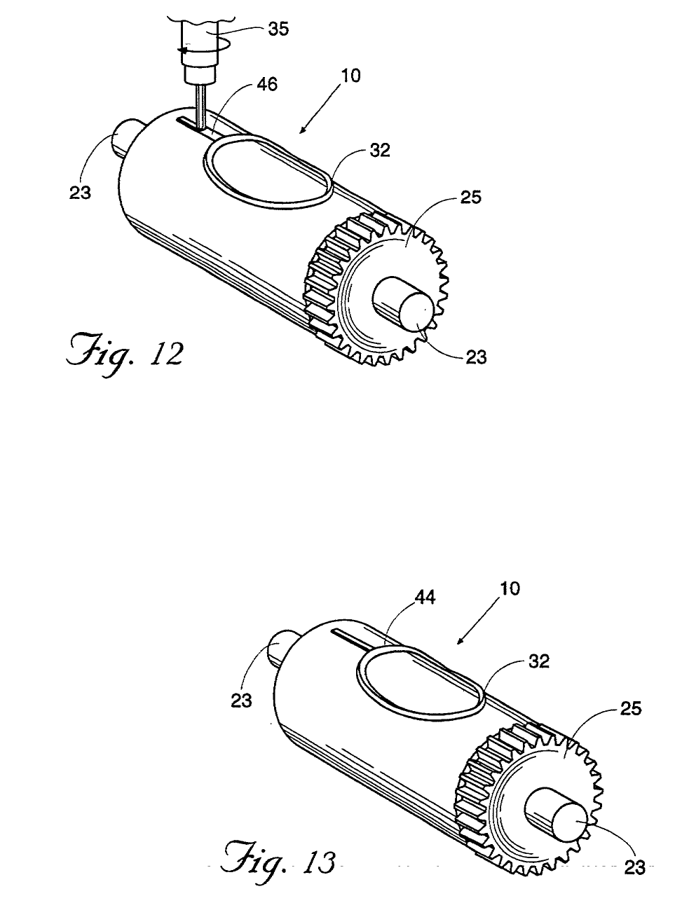

With reference to FIGS. 2-4, inclusive, the flat blank 30 provides a supporting base for the mold forming process. As illustrated, the flat blank material 30 is routed into a form 40 for use as a mold for forming a cutting or working edge 32 on the cylindrical base member 21. The form 40 formed from stock material 30 provides a rectangular form which may be rolled onto the cylindrical support member 21. Prior to the tubular forming, a relatively flat blank 30 is machined to provide a molding riser groove 38 and finished molding grooves 34. The machined flat material 30 provides a mold 40 for a working or cutting edge 32 of the rotary die cutter 10 (seen in FIGS. 12 and 13). The blank stock material 30 may be of any size, shape, and material that is suitable for the process described herein. Preferably, the length L of the blank stock material 30 should be slightly greater than the circumference of the rotary die blank 20, as the stock material 30, when in the completed mold form, 40 will be wrapped around the rotary die blank 20 during the rotary cutting die 10 manufacturing process, as will be discussed herein. The width W of the bland stock material 30 is preferably less than or equal to the length of the cylindrical support 21, although it is within the scope of this disclosure to include cylindrical support 21 lengths of larger dimension.

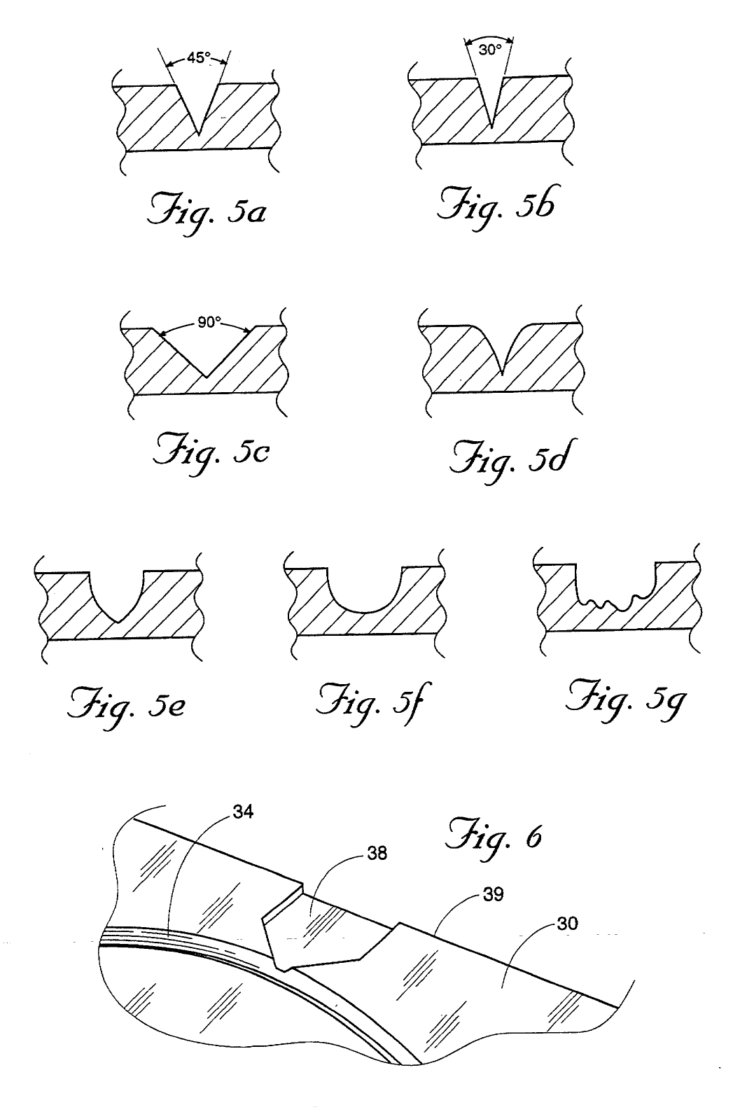

As disclosed in FIG. 2, a molding groove 34 is routed into the blank stock material 30, preferably by a machining tool 35 having a rotary bit 36 to create the molding form 40. The blank stock material 30 thereby provides the base of a molding form 40 to mold the cutting edge 32 of the rotary cutting die 10. To this end, the inverse of the cutting edge peripheral surface is machined away, at 34. While the Figures depict the form 40 having a circular groove 34, it should be understood that the molding groove 34 may be machined to produce any desired configuration, such as those configurations shown in FIGS. 4a, and 5a-5g, inclusive.

Alternatively, the groove 34 may be manually formed in cases where a simple cutting edge 32 configuration is desired, however, it is presently believed preferable to form the groove 34 with an automatic, computer numerically controlled (CNC) machine 35 having a cutting tool 36a. CNC machining assures precise and accurate location of the groove 34 and allows the groove 34 to conform within exacting parameters to the desired predetermined configuration of the cutting edge 32 to be formed. A master design layout programmed into the CNC machine allows for this precision. Furthermore, the cross sectional width C and depth D of the groove 34, seen in FIG. 4a, is critical and greatly depends upon the accuracy of the machining discussed above.

As seen in FIGS. 2 through 4a, the machining tool 35 used to form the groove 34 preferably employs a rotary bit 36 with a tip having a “v” shaped cross-section terminating with a sharp point. This configuration allows variation in groove 34 shape as may be desired.

As seen in FIGS. 4a, and 5a-5g, inclusive, the angle Ø between the side walls 37 of the groove 34 may be varied to suit the particular cutting application desired for the rotary cutting die 10 to be manufactured. Further, while such a “v” shape may be suitable for most applications, other cross-sectional shapes may be employed based on the particular application. Some examples of alternative cross-sectional groove 34 shapes are illustrated in FIGS. 5d-5g. It is to be understood that the mold groove 34 cross-sectional shape is not to be limited by the examples shown in the Figures, but may be of any desired configuration necessary to produce various cutting edges 32. It is to be understood that other types of working edges may be produced through modification of groove 34 in the form 40. For example, FIG. 5f illustrates a cross-section of a groove 34 used to mold a creasing or scoring edge. An edge produced by the mold seen in FIG. 5f functions in conjunction with coacting grooves (not shown) on an anvil roller 26 to impart creases along predetermined lines on box blanks for example, thereby facilitating folding of carton flaps or the like. An edge made by the mold of FIG. 5f is not intended to cut, and is therefore rounded off to provide a small arcuate contour. The mold seen in FIG. 5f may be further calibrated to ensure that the resulting molded edge 32 is located below the reference diameter by an amount which is substantially equal to the thickness of the stock material 13 being processed. Further, the working edge 32 may be configured as seen in FIG. 5g for embossing of such stock material 13 as floor tile, linoleum, or sheet metal (not seen in these views).

A cutting, or working edge 32 made according to the present invention may also be adapted to cut partially through the blanks. In this example, the cutting edge 32 is created by a mold similar to those shown in FIGS. 5a-5e, but the edge 32 is located below a reference diameter by an amount which is substantially equal to one-half the thickness of the carton stock.

It is conceivable that the machining process may be accomplished using a number of rotary bits 36, each having a unique cross-section, to precisely cut a groove 34 that is not capable of being cut by a single tool. The cross section of such a groove 34 could be configured differently on either side of its central vertical axis. Alternatively, if an appropriate flat blank stock material 30 is used, the groove 34 may be cut or burned away by a laser in a laser cutting, rapid prototyping or similar type machine (not shown).

Referring now to FIG. 3, at least one riser groove 38 is cut into the blank stock material 30. Each riser groove 38 extends from molding groove 34 to a lengthwise edge 39 of the stock material 30. If more than one riser groove 38 is used, then all risers 38 should extend to the same lengthwise edge 39 of stock material 30. Additionally, the riser grooves 38 are preferably cut into the stock 30 to a depth less than the groove 34, and, as seen particularly in FIG. 6, the riser grooves 38 may be of substantially larger width than the molding groove 34. A riser groove 38 that is both wider and shallower than molding groove 34 is preferred, as will become apparent as the molding procedure is described.

While it is believed preferable to cut the risers 38 using a modified bit 36 that terminates in a “u” shape or semicircle rather than the sharp point of the bit 36 used for molding groove 34, it may be desired to use a single bit 36 to cut the molding groove 34 and riser groove(s) 38 in the same operation. If a single bit 36 is used, manufacture of the rotary die 10 will require an additional step, as will be discussed later in the assembly process.

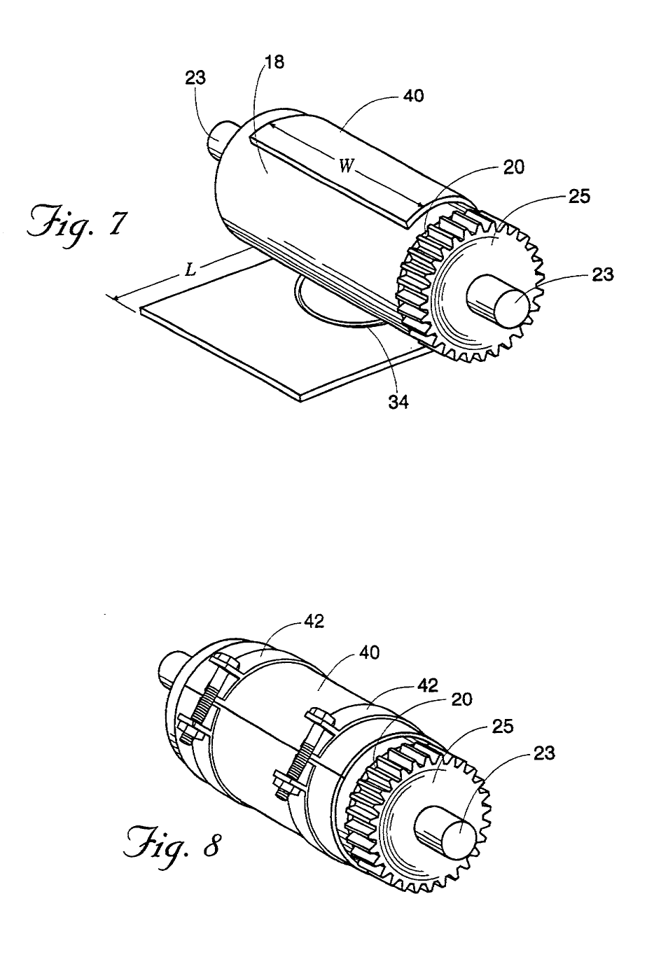

Referring now to FIGS. 7 through 13, the preferred rotary die 10 manufacturing process is illustrated. As seen particularly in FIG. 7, the machined mold form 40 is wrapped circumferentially around a rotary die blank 20. The machined side of the form 40 is located facing the surface 18 of the die blank 20, with the cutter groove 34 and riser groove 38 located directly adjacent to the peripheral surface 18 of the die blank 20. As seen in FIG. 8, at least one clamp 42 is placed around the mold form 40 and is tightened to a predetermined torque. The clamps 42 assure firm contact between the form 40 and around the entire peripheral surface 18 of die blank 20.

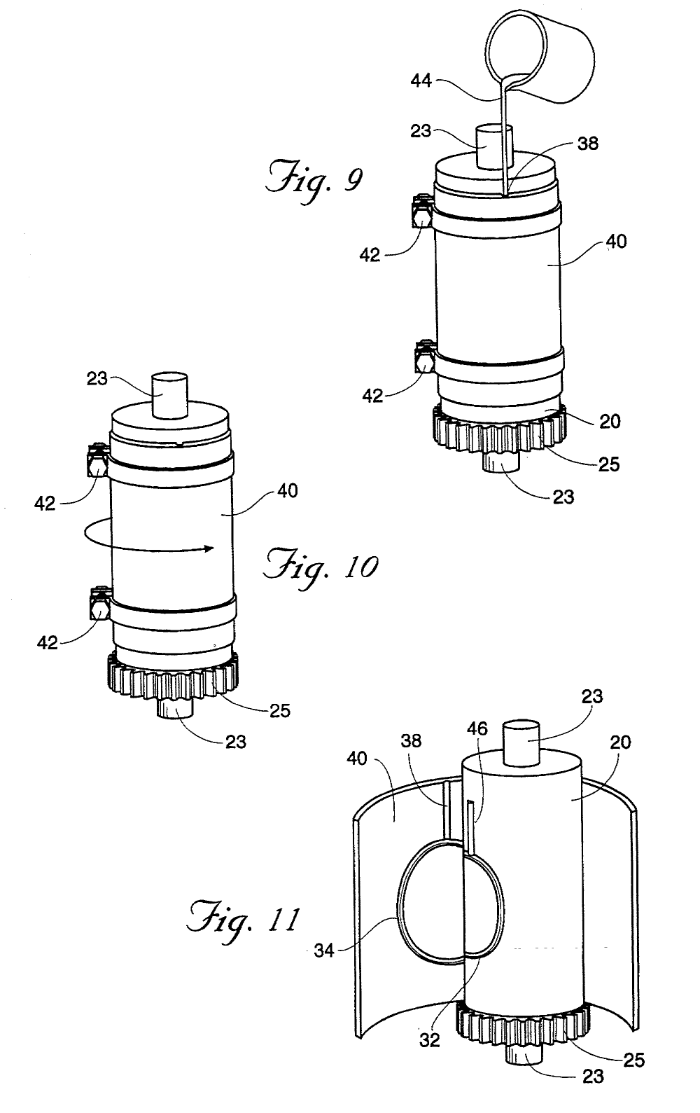

As depicted in FIG. 9, the die blank 20 with attached form 40 and clamps 42 is preferably positioned with the form riser groove(s) 38 extending upwardly relative to the longitudinal axis of the axially extending support journals 23. Molten cutting edge material 44 is then poured, injected or otherwise inserted into the riser groove(s) 38, where the material 44 will travel downwardly to fill the molding groove 34. The cutting edge material 44 may be any material capable of solidification to form a working edge 32. While steel has traditionally been used as the cutting edge, the present invention preferably uses a ceramic composite, such as zirconia oxide, alumina silicate, silicon carbide, or alumina as may be obtained from Cotronics Corp., Brooklyn, N.Y. under the trademark RESCOR®.

Ceramic materials have a number of benefits over traditional metals when used as a cutting edge. While most ceramic materials are capable of flexion similar to steel, the ceramic blade is non-magnetic, anti-static, and has lower friction and adhesion properties than a comparable steel blade, thereby producing a cleaner cut. Ceramics will not oxidize or corrode, and can operate in a high temperature environment without the hardness loss associated with steel. In service, ceramic edges wear by losing small chips or flakes of material. These scratches, nicks, spalling and other surface attrition that normally dull a cutting edge create fractures in the grains of the ceramic material, thereby exposing new available cutting surfaces. These characteristics allow a ceramic edge service life to be fifty to one hundred times that of a traditional steel edge. Additionally, fine chips of diamond, boron carbide or other materials of extremely high hardness may be included in the ceramic cutting edge material 44 to further improve performance. It is also contemplated that edge material 44 other than molten ceramic may be utilized. Any material that may be injected into the groove 34 as a liquid that will harden to form a working cutting edge 32 may be used. For example, a ceramic slip may be injected as a liquid at room temperature, but will harden over a predetermined time. Also contemplated is the use of materials that will remain liquid until certain environmental conditions are met, whereby the material solidifies. Such conditions include exposure to certain waveforms such as certain frequency vibrations, sound or light. Further contemplated is use of material which requires specific changes in other materials used in the manufacturing process. For example, if one light type causes solidification, an opaque form 40 may be used to allow passage of light through the form to the material 44.

After the cutting edge material 44 is introduced and fills the groove 34, the die blank 20 assembly and attached form 40 is preferably shaken and spun, as seen in FIG. 10. Spinning is of particular importance, as centrifugal force pushes the edge material 44 well into the groove 34, to ensure that the finished cutting edge 32 is sharp and well defined. After the spinning step, the edge material 44 in the form 40 is allowed to cool to a predetermined temperature. The cooling process is preferably monitored and controlled to ensure that the material 44 retains the desired properties, thereby assuring that the final cutting edge 32 also retains the desired characteristics.

After the cutting edge material 44 has hardened, the clamps 42 and the form 40 are removed from the rotary die blank 20, leaving the finished cutting edge 32 attached to the rotary die 20, as shown in FIG. 11. The form 40 may then be used on further die blanks 20 to produce additional edges 32.

An optional step may be performed to help prevent the cutting edge material 44 from attaching to the form 40. Prior to placing the form 40 around the die blank 20, a non-stick, release coating (not shown) may be applied to the form 40. Such a coating may be temporary, and applied before each use of the form 40. Alternatively, it is within the scope of this invention to apply a permanent coating to form 40 prior to forming cutting edge 32. Examples of mold release coatings are Forsch's Liquid Release obtained from Forsch Polymer Corp., Denver, Colo. and Replicast 101 MR or 102 MR Mold Release obtainable from Contronics Corp.

As seen in FIG. 12, excess material 46 left by the riser(s) 38 may be machined away. This step is necessary if the excess riser material 46 is arranged in a way that may cause interference when the rotary cutting die 10 is in service. It is to be noted that the entire excess 46 need not be taken off and that it is necessary to remove the excess material 46 to the extent that it creates sharp edges that may cause unwanted cuts in the stock material 13 to be die cut. As indicated with reference to FIG. 6, a riser groove 38 that is cut more shallow than, and wider than the groove 34 may alleviate the step shown in FIG. 12.

A completed embodiment of the rotary die 10 of the present invention is depicted in FIG. 13. A rotary die 10 made according to the present invention is more economical to manufacture than traditional die cutters due to use of a less expensive base material 21, less milling, and the improved service life a ceramic cutting edge allows.

While the description has been directed primarily to the formation of cutting edges 32 about the periphery of the rotary die blank 20, it is to be understood that the present invention may be utilized with advantage in the manufacture of flat dies for platen type or flat bed presses. Furthermore, it is to be understood that the working edge 32 may be configured as, in addition to a cutting edge, a folding, scoring, perforating, embossing or any other working edge that may be formed by the disclosed method.

While the disclosure hereinabove has been directed to a preferred embodiment of the invention and the procedure for fabricating same, modifications of the die as well as in the method of fabricating it will become apparent to those skilled in the art.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention,which is defined by the claims.

What is claimed is:

1. An apparatus for working sheet material into die cut, creased, and scored products, the apparatus comprising:
a die blank having a relatively smooth surface; and
a working edge extending laterally from and being molded to said smooth surface.

2. The apparatus of claim 1, wherein said working edge is molded from ceramic material.

3. The apparatus of claim 2, wherein said ceramic material includes a filler of relatively hard chip material.

4. The apparatus of claim 3, wherein the filler comprises diamond chips.

5. The apparatus of claim 3, wherein the filler comprises boron carbide chips.

6. The apparatus of claim 3, wherein the filler comprises zirconia chips.

7. The apparatus of claim 2, wherein said working edge is configured to provide a sheet material creasing edge.

8. The apparatus of claim 2, wherein said working edge is configured to provide a sheet material cut-scoring edge.

9. The apparatus of claim 2, wherein the working edge is configured to provide a sheet material pre-perforating edge.

10. The apparatus of claim 1, wherein the smooth surface of said die blank is cylindrical.

11. The apparatus of claim 1, wherein said working edge is molded to said smooth surface to provide triangular cross section with its base conforming to and supporting by said smooth surface and the triangular sides converging to define an apex laterally extending from said base.

12. The apparatus of claim 1, wherein said working edge is molded to said smooth surface to provide a substantially arcuate cross sectional portion having a base conforming to and supported by said smooth surface extending laterally from said smooth surface.

13. The apparatus of claim 1, wherein said working edge is molded to said smooth surface to provide a creasing edge of substantially arcuate cross-sectional portion extending laterally from said smooth surface and having a base conforming to and supported by said smooth surface.

14. The apparatus of claim 1, wherein the smooth surface of said die blank is a flat planar surface.

15. A method for making a working die for working sheet material, the method comprising the steps of:
providing a base material;
forming a pre-determined groove configuration in said base material;
providing a die blank with a relatively smooth surface;
forming a pre-determined groove configuration in said base material;
positioning said base material adjacent to said die blank and with said groove configuration facing said smooth surface of said die blank;
filling said groove configuration with a liquid material that will solidify to form a working edge; and
removing said base material from said die blank, whereby a working edge adheres to said smooth surface and is supported by said smooth surface of said die blank.

16. The method of claim 15, wherein said die blank is in the form of a cylinder having and outer surface; and
said base material is configured to conform to the cylindrical outer surface of said die blank cylinder.

17. The method of claim 15, wherein the step of filling said groove configuration is preceded by the step of clamping said base material about the peripheral surface of said cylindrical die blank.

18. The method of claim 15, wherein the step of filling of said groove configuration is preceded by applying a mold release material to said base material.

19. The method of claim 15, wherein said die blank includes a relatively flat, planar, smooth surface.
